(19) United States
(12) Patent Application Publication
(10) Pub. No.: US 2012/0096667 A1
(43) Pub. Date: Apr. 26, 2012

(54) Windshield Wiper Blade Refill Suited for Removal of Solid Material

(76) Inventor: Jeffrey Cooper, New Holland, IL (US)

(21) Appl. No.: 13/112,417

(22) Filed: May 20, 2011

Related U.S. Application Data
(60) Provisional application No. 61/394,870, filed on Oct. 20, 2010.

(51) Int. Cl. B60S 1/34

(52) U.S. Cl. 15/250.48

(57) ABSTRACT

A wiper blade device with a durable mesh sponge member attached between two traditional wiper blade members of triangular cross section. The combination sponge and wiper blade construction provides a unitary device that combines the two distinct functions of cleaning solids and wiping water from vehicular windshields. The device includes a slideable ridge attachment such that it is easily replaceable as needed, as well as end caps to ensure secure fitment during operation. The device further provides minimal windshield obstruction given its construction, improving current wiper blade capabilities without degrading visibility or impacting safety of the vehicle. The device may comprise a wiper blade refill attachable to a wiper blade mount, providing the practitioner with an improved windshield wiper blade that is cost effective and one that requires no modification of the vehicle to implement.

### CROSS REFERENCE TO RELATED APPLICATION

This application claims the benefit of U.S. Provisional Application No. 61/394,870 filed on Oct. 20, 2010, entitled “Windshield Wiper Blade.”

### BACKGROUND OF THE INVENTION

1. Field of the Invention

The present invention relates to a unitary device combining the two distinct functions of cleaning solids and wiping water from vehicular windshields. It is generally well known in the field that windshield wipers are effective for removing water, but they are relatively ineffective for removing solids such as solid insect remains and bird droppings without creating extensive and potentially dangerous smears. The smears are caused by the rubber squeegee action of the blades, which tends to smear solids into a thin film by forcing it against the glass surface rather than scooping it or brushing it away. Consequently, the driving practitioner may be forced to halt their vehicle to scrub off solid matter manually or risk further driving with obscured vision through the windshield.

In certain geographic locations and climates, it is common for airborne bugs and insects to collide with, and become compressed against, the windshield of a vehicle. The accumulation of such bugs, insects and other debris on the windshield is greatest when the vehicle is in operation, but significant accumulation can also occur when the vehicle is stationary for a long period. This is particularly true of bird droppings and cars parked in wooded areas for periods of time. Removal of bugs, insects and other debris attached to the windshield is imperative to ensure safe operation of the vehicle as accumulation can significantly impair the driver's vision and line of sight.

The most effective means of removing the accumulated bugs, insects and other debris is to hand wipe the windshield with a towel combined with a solvent or cleaner. However, this form of cleaning is not always possible or feasible during the operation of a moving vehicle. In such instances, the driver must rely on using windshield wipers, which are designed to remove accumulation of water rather than solid debris. Wiper blades are constructed of rubber or a similarly flexible material in order to conform to the sloped surface of the windshield for effective removal of water or other liquids. However, wiper blades are generally ineffective for removing or dislodging these solid materials, particularly those which are stuck, bonded, or otherwise attached to the exterior surface of a windshield and are not easily ushered away by the wiper's sweeping action. There exists a need for a device capable of removing bugs, insects and other debris from the windshield of a car without user intervention. Further, such a device should be easily removable and replaceable, and require no modification to the standard vehicle wiper blades or wiper mounts.

2. Description of the Prior Art

Numerous designs for windshield wipers have been provided in the prior art. Even though these designs may be suitable for the specific individual purposes to which they address, these prior art devices have several known drawbacks. Specifically, such devices do not include or suggest a wiper blade system that is removable and replaceable and works with a conventional wiper blade or wiper blade mounting arm.

Several prior art patents address the issue of adding a scrubbing sponge portion in parallel with traditional blades. However, these devices are non-standard or significantly larger than traditional wiper blades. As such, they are likely to require costly modification to the wiper mount or potentially obscure visibility. Gilliam, III U.S. Pat. No. 4,649,593 is directed to a combined windshield wiping and cleaning device having a scrubbing member with a reticular surface for removing solid matter along with a wiper member with squeegee for removal of water. These are attached together with a supporting base as a single monolithic extrusion of an elastomeric material. The Gilliam invention fits into the windshield wiper arm in the same way as current blades.

Similarly, Kinder U.S. Pat. No. 5,235,720 is directed to a windshield scrubbing and wiping blade assembly including a scrubbing blade, having a mesh covered scrubbing portion, and at least one wiping blade in parallel, spaced apart in relationship with the scrubbing blade. The mesh and the associated scrubbing portion of the scrubbing blade define side channels for receiving and transporting debris removed by the mesh from the windshield. In the two bladed embodiment of the invention, the scrubbing blade is shorter than the wiping blade and is maintained out of contact with the windshield during the portion of the wiping cycle in which the scrubbing blade trails the wiping blade. Hipke U.S. Pat. No. 5,406,672 is directed to a windshield wiper blade system comprising an elastomeric wiper blade, an elongated base portion, a coupling mechanism for coupling the base portion; a squeegee coupled to the base portion and extended downwards therefrom to contact the surface of a windshield; and a scrubbing blade. The scrubbing blade further comprises a sponge extended along and coupled to the base portion near the squeegee with the sponge having a surface adapted to conform with the surface of a windshield; and webbing disposed about the sponge and defining a scrubbing surface. Thus, when the system swipes back and forth across the surface of the windshield the wiper blade and the scrubbing blade remove both water and bugs.

Additionally, Hsieh U.S. Pat. No. 6,622,337 is directed to a wiper blade for a car comprising a seat part, a moisture absorptive part, and a sweep part. The seat part is an elongated strip made of non-absorptive material. The moisture absorptive part is made of water absorbable material and has a length and a width thereof corresponding to the seat part for joining with the seat part. The sweep part is an elongated strip with a gap and has a size corresponding to the absorptive part for joining with the absorptive part. The moisture absorptive part can keep the sprayed water for next wipe as soon as the sweep part removes the foreign substances on a windshield of the car. Root U.S. Pat. No. 6,748,621 is directed to a vehicle windshield wiper assembly for providing a user with a set of windshield wipers for motor vehicles designed to scrub insects off the glass. The blade member is for providing support to a plurality of cleaning members and a cleaning blade. The cleaning members and the cleaning blade are for facilitating cleaning of debris the windshield of a vehicle.

The Gilliam, Kinder, Hipke, Hsieh and Root inventions all describe large replacements for traditional wiper blades. Such replacements include both one or more standard blade members and one or more sponge members. Each of these inventions is non-standard, and significantly larger than traditional wiper blades. As such, they may subject the practitioner to reduced or obscured visibility during vehicle operation. The present invention fits over or replaces a standard wiper blade. Thus, there is limited visibility loss, both during the operation of the windshield wipers, and while the wipers are at rest at the base of the windshield.

Perry U.S. Pat. No. 5,301,384 is directed to a vehicular window cleaning apparatus having a wiper arm, wiper blade and drive means in combination with a scrubber for intensifying the cleaning effort of the wiper blade. The scrubber is detachably connected to the wiper blade. An adjustment means is provided for rotating the wiper blade relative to the wiper arm sequentially positioning the wiper blade and scrubber against an associated windshield. The Perry invention requires the installation of a non-standard articulator control for the sponge portion, requiring a costly deviation from traditional wipers.

Gold U.S. Pat. No. 5,634,841 is directed to an apparatus for removing scratches and/or stains from a vehicle windshield includes a cylindrical sponge having a radial opening which fits snugly over a windshield wiper blade with the windshield wiper arm connected to the blade through the radial opening in the cylindrical sponge. The methods of the invention include moistening the cylindrical sponge and applying a polishing abrasive. Activating the vehicle windshield wiper wipes the abrasive on the windshield with the sponge. Other methods of the invention include impregnating the sponge with a polishing abrasive or moistening the sponge with windshield washer fluid. The device described in Gold is not a windshield wiper in the traditional sense; rather the Gold invention describes a device and means of repairing and improving windshields, and is thus not analogous to the present invention.

Other devices described in the prior art simply add a sponge component to current wiper blades. Squires U.S. Pat. No. 6,505,378 is direct toward a wiper assembly for providing additional scrubbing surface area. The wiper assembly includes a wiper blade designed for coupling to a wiper arm of a vehicle; a scrubbing member, which couples to the wiper blade for removing debris from the windshield; and a plurality of clip members for coupling the scrubbing member to the wiper blade. Similarly, Cabak U.S. Pat. No. 7,707,681 is directed to a windshield wiper clip adapted for connecting a scrubbing blade to a windshield wiper, wherein the clip connects a scrubber to a wiper in order to accommodate bug removal during movement of the wiper about a windshield. The invention also includes an integrated clip and scrubber, as well as wiper-scrubber system. A novel scrubber mount having rounded shoulders is also described. By simply adding a sponge component to current wiper blades, the Squires and Cabak inventions do not describe a complete system of blades and sponges. Further, the Squires and Cabak inventions greatly increase the size of the wiper assembly, risking obscured vision during vehicle operation.

The present invention differs from the prior art in that it offers an easily removeable and replaceable wiper blade refill that fits onto any standard blade or mounting arm. The blade members and sponge member are substantially the same size, resulting in no loss of visibility during vehicle and wiper operation. Additionally, the present invention does not require costly non-standard mounts or modifications to the standard wiper assembly. Further, having two blade members allows for optimal cleaning of debris, such that smears are unlikely whether the wiper is moving up or down on the windshield. The present invention will greatly assist vehicle users in preventing bugs and other debris from remaining lodged upon the windshield. Practitioners will be capable of easily cleaning the windshield during vehicle operation without any significant modification to their wiper blade assemblies. Further, users will find the present invention easy to install and replace when needed.

### SUMMARY OF THE INVENTION

In view of the foregoing disadvantages inherent in the known types of wiper blades now present in the prior art, the present invention provides a new wiper blade and sponge system wherein the same can be utilized for providing convenience for the user when removing bugs or other sticky debris from their windshield while operating a motor vehicle.

The present invention is a removeable replaceable windshield wiper refill system that utilizes a netted sponge for cleaning debris instantly from the windshield in conjunction with two wiper blade members for water removal. The inner sponge is comprised of a netted mesh, mounted between two blades and inset slightly for optimum efficiency. The present invention allows the practitioner to clean debris anytime and anywhere from the windshield while operating their motor vehicle. The present invention is designed such that a squirt of wiper fluid will wet the sponge, allowing the most dried on and persistent smears to be efficiently cleaned from the windshield. The present invention is composed of one solid unit that can be removed and replaced easily and inexpensively manufactured. Further, the present invention is made in all typical windshield wiper lengths and will fit any of the current windshield wiper mounts.

The present invention will comprise of a base component made of hard plastic, rubber or metal that is shaped for use as a blade refill, capable of attachment to a standard windshield wiper frame or wiper mount. The present invention further has two wiper blade components made of durable rubber or silicone, positioned to abut with the windshield outer surface. Attached between the two blades is a sponge component made of dense sponge material wrapped in durable nylon mesh netting for grabbing debris. The present invention is distinguished from prior art in that: it will clean, scrub, and remove debris quickly; has the simplicity of only being one piece to be easily changed; and is designed to fit any current standard wiper blade rail or wiper blade mount.

The primary object of the present invention is to utilize the mesh netted sponge between two wiper blades to quickly remove debris such as mud, sap or bug remains when crossing the windshield with a minimal number of passes. Minimizing the number of swipes ensures the vehicle operator will not encounter a loss of visibility.

A secondary object of the present invention is to provide a wiper device that will clip or slide onto any type of wiper blade or alternatively, attach to any type of wiper blade arm mount. The present invention has a mesh netted sponge positioned in between double rubber or silicon blade member to better clean debris from the windshield. The netted sponge runs the entire length of the blades and is slightly inset to prevent overlap with the blades during operation.

It is a further object of the invention to provide at least one scrubbing member comprising a net covered sponge member arranged in parallel with to two elongated rubber or silicon wiper members of generally conventional design. Both the wiper function and the scrubbing function are supported by a common base along the entire length of each member, wherein the base is adapted to be held in place and operated by a windshield wiper blade arm mount or wiper blade assembly which may be of conventional design.

Other objects, features and advantages of the present invention will become apparent from the following detailed description taken in conjunction with the accompanying drawings.

### BRIEF DESCRIPTIONS OF THE DRAWINGS

FIG. 1 is a perspective view of the present invention, with a close-up perspective view of the terminal end of the blades and scrubbing member.

FIG. 2 is a perspective view of the present invention in use, attached to a standard wiper blade assembly, with a close-up perspective view of the end caps for attachment.

### DETAILED DESCRIPTION OF THE INVENTION

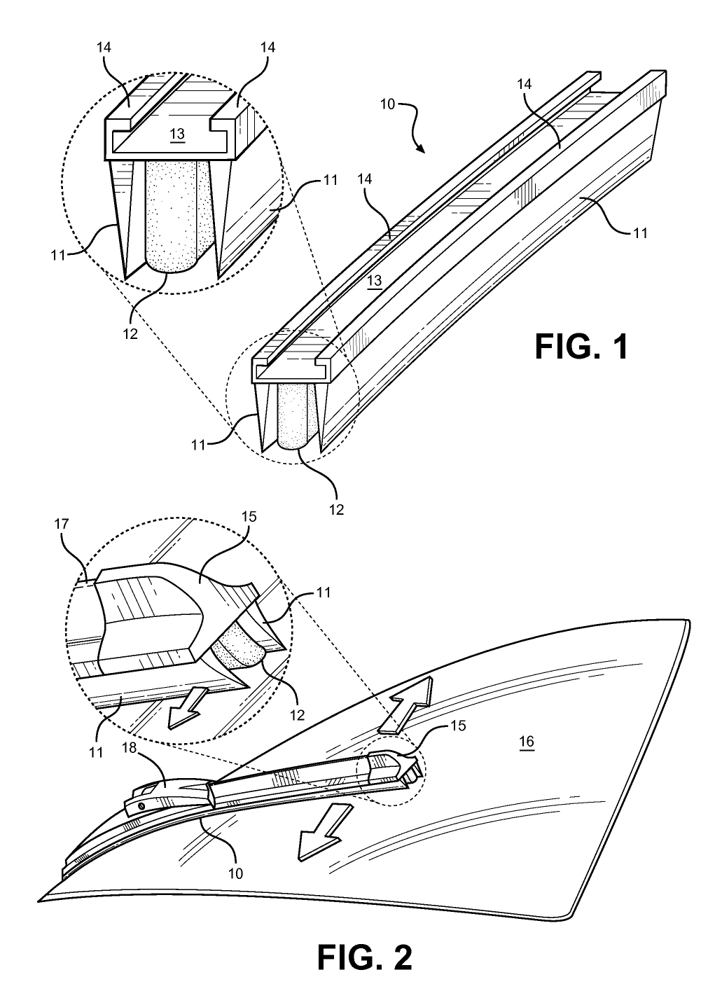

Referring now to FIG. 1, there is shown a perspective view of the present invention, with a close-up perspective view of the terminal end of the blades 11 and the internal scrubbing member 12. The present invention 10 consists of a pair of rubber or silicone wiper blade members 11 attached on either side of a mesh netting sponge member 12 to a base component 13. The base component 13 may be made of metal, rubber or any other suitable material, and is equipped with slideable ridges 14 allowing attachment to any standard wiper blade assembly 17 or wiper mount arm 18. The ridges provide the assembly to function as a blade refill for a standard wiper mount arm 18. The close-up view demonstrates the terminal end of the device 10, showing the base component 13 with the slideable ridges for attachment 14, as well as the mesh net sponge 12 attached in between the wiper blade members 11.

Referring now to FIG. 2, there is shown a perspective view of the present invention in use, attached to a standard wiper blade assembly, with a close-up perspective view of the end caps for attachment. The present invention 10 is attached over a traditional wiper blade 17 or to a wiper blade mount 18 using the slideable ridges 14 on the base component 13. When the device 10 is attached, end caps 15 are placed on the terminal ends of the device 10 and the standard wipers 17, preventing inadvertent removal. FIG. 2 illustrates the device 10 in use on a typical vehicle windshield 16. The close up demonstrates the terminal end of the device when attached to a standard windshield wiper 17, and shows the mesh net sponge 12 in between the two blade members 11, with the end cap 15 to secure the device.

In use an individual attaches the device 10 to a standard windshield wiper 17 or wiper mount arm 18, using the slideable ridges 14 and terminal end caps 15. When the vehicle wiper mechanism activates, the device 10, will swipe across the surface of the windshield 16. In use, the device will first pass over the bugs or debris with a blade member 11, then scrub the bugs or debris with the sponge 12, then again with a second blade member 11 in a single pass. Ideally, practitioners will moisten the mesh net sponge portion 12 of the device 10 with windshield wiper fluid. The mesh net sponge 12 is slightly shorter than the two wiper blade members 11, thus ensuring that no overlap will occur during usage. When activated the blade will swipe across the windshield 16, the blade members 11 and sponge 12 will deflect slightly without overlap to conform to the shape of the windshield 16.

The practical design of the device 10, allows for easy removal and replacement when one or more portions have worn. Replacement will simply involve sliding the worn device 12 from the wiper blade 17 or mount 18, sliding a new device on and affixing the end caps 15 to prevent relative movement. The blade members 11 may be made of rubber, silicon or any other appropriate material. The sponge 12 may be covered with a mesh netting of nylon or any other material, such that it is highly durable and capable of scrubbing without scratching the windshield. The sponge 12 will also be slightly shorter than the two blade members 11, with gaps on either side to prevent overlap during the swiping process and to better clean away bugs and other debris from the windshield. Further, the device 10 is the same size and shape as traditional wipers, thus maintaining optimal visibility for the user.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A combination windshield cleaning and wiping refill device comprising:
a base component having slideable ridges disposed along an upper surface, wherein said ridges are adapted to removably secure said base component directly to a wiper blade or wiper blade mount;
two terminal end caps to removeably affix said base component to said wiper blade or wiper blade mount;
two blade members attached to a lower surface of said base component;
and a mesh net covered sponge attached to a lower surface of said base component between and slightly shorter than said blade members.

2) The device of claim 1, wherein said blade members and said sponge do not overlap during usage.

3) The device of claim 1, wherein said mesh net surface of said sponge is made of nylon, optimal for cleaning debris without scratching or damaging the surface of the windshield.

4) The device of claim 1, wherein said blade members are made of rubber.

5) The device of claim 1, wherein said blade members are made of silicone.

6) The device of claim 1, wherein said base component is made of rubber.

7) The device of claim 1, wherein said base component is made of metal.

8) (canceled)

9) (canceled)

10) (canceled)

11) (canceled)

12) (canceled)

13) (canceled)

14) (canceled)
